(19) United States
(12) Patent Application Publication
(10) Pub. No.: US 2013/0098741 A1
(43) Pub. Date: Apr. 25, 2013

(54) METHOD FOR PRODUCING A SWITCHING MEMBRANE

(71) Applicants: Hylke VEENSTRA, Reuver (NL); Paul VAN MIERLO, (US); Matheus WIJNSTEKERS, Velden (NL); Henricus Cornelis Maria VAN GENUCHTEN, Eindhoven (NL)

(72) Inventors: Hylke VEENSTRA, Reuver (NL); Paul VAN MIERLO, (US); Matheus WIJNSTEKERS, Velden (NL); Henricus Cornelis Maria VAN GENUCHTEN, Eindhoven (NL)

(73) Assignee: OCE TECHNOLOGIES B.V., Venlo (NL)

(21) Appl. No.: 13/530,810

(22) Filed: Jun. 22, 2012

(30) Foreign Application Priority Data
Jul. 1, 2011 (EP) 11172319.3

(51) Int. Cl. B41J 2/01; H01H 9/18

(52) U.S. Cl. CPC B41J 2/01; H01H 9/18
USPC 200/308; 347/102

(57) ABSTRACT

In a method a membrane for switching operation is made by providing a transparent sheet, forming a graphical layer by image-wise providing a curable ink layer using inkjet printing on a surface of the transparent sheet, wherein the graphical layer has a thickness of at most 35 micron, curing the graphical layer, and forming a flexible layer by providing an ink layer using screen printing over the graphical layer.

The switching membrane is durable for switching operation and may be made at low-cost in small quantities.

### FIELD OF THE INVENTION

The present invention relates to a method for producing a durable and low-cost membrane in small quantities for switching operation.

### BACKGROUND OF THE INVENTION

A membrane is commonly used as switching indicators in many applications, such as domestic applications (e.g. magnetron applications), industrial applications (e.g. process control display), telecommunication (e.g. mobile telephone applications), etc. The membrane commonly comprises several layers such as a transparent sheet, a graphical layer and a flexible backing layer. The graphical layer provides an image, for example for switching indicators, and the flexible backing layer provides a background color, usually white, for such image. The flexible backing layer is usually opaque, but may be (locally) translucent to a predetermined extent to allow backlighting of the switching membrane.

A conventional membrane for switching operation is made by providing several ink layers using a screen printing technique. This technique is economically feasible for large quantities of switching membranes. However for making small quantities of the membrane, the screen printing technique may be too expensive e.g. due to relatively high costs for preparing a set of suitable screens.

Alternatively a membrane may also be obtained by using a digital printing technique to print an ink, such as inkjet printing. By using a digital printing technique a membrane may be obtained in small quantities at relatively low costs. Other advantages of inkjet printing compared to screen printing are the ability of easily printing certain graphical expressions like photos or color gradients.

A drawback of using an inkjet technique for making the graphical layer and the flexible backing layer of membrane is that the resulting membrane has a very limited durability: it has been found that the image-forming ink layers are not mechanically resistant to frequent deformation during switching operation.

### SUMMARY OF THE INVENTION

It has been found by the inventors that a durable membrane for indicating a switch button for switching operation may be made by the method comprising the steps of: a) providing a transparent sheet, b) forming a graphical layer by image-wise providing a curable ink layer using inkjet printing on a surface of the transparent sheet, wherein the graphical layer has a thickness of at most 35 micron, c) curing the graphical layer, and d) forming a flexible layer by providing an ink layer using a printing technique other than inkjet printing over the graphical layer.

According to the invention the graphical layer is formed by using inkjet technique and the flexible layer is formed by using another printing technique. The flexible layer is flexible in order to provide durability for switching operation. Preferably the flexible layer may be formed by using screen printing. The flexible layer may be formed by using flexography, offset printing, gravure printing, pad printing, etc.

It has been found that the thickness of the graphical layer is essential for achieving a good durability of the membrane for switching operation. The thickness of the graphical layer is at most 35 micron. The thickness of the graphical layer can be controlled very accurately using inkjet printing (e.g. by suitably selecting a droplet size, droplet spreading, droplet positioning, number of ink layers), while a high quality (e.g. high-resolution) image may be obtained.

The flexible layer may be formed by using screen printing technique. The flexible layer may be relatively thin (e.g. 10 microns) while obtaining an opaque backing color, such as white. The flexible layer may have a simple (monochrome) background color. The flexible layer may be formed at relatively low cost of production by using screen printing, since a the layer thickness having a suitable opacity is thinner for screen printing than for inkjet printing and a single screen for an even background color is not image dependent and therefore such screen may be used for different images or batches of switching membranes.

The production method for the membrane is suitable to produce a small number of membranes at relatively low cost. The mechanical durability of the membrane is improved for operating the (manual) switch for at least 1 million times, whereby the membrane is not visibly degraded.

The transparent sheet, which is provided in step a), may be made of any flexible material, such as thermoplastic polymers, which is suitable for deformation during switching operation. The thickness of the transparent sheet is not critical for the membrane.

The graphical layer is formed by image-wise providing a curable ink layer using an inkjet printing technique in step b). The resulting graphical layer may provide an image to the switching membrane. The image in the switching membrane may indicate locations of one or a plurality of switching elements behind the switching membrane and may also indicate the function of the (plurality of) switching element(s).

The image is provided by using an inkjet printing technique. In an inkjet printing technique a plurality of print heads may be used to provide inkjet droplets, which inkjet droplets may be positioned on the surface of the transparent sheet, thereby image-wise forming a curable ink layer. For positioning of the inkjet droplets on the surface of the transparent sheet, the plurality of inkjet print heads may be moved with respect to a stationary position of the transparent sheet.

An amount of curable ink is used for inkjet printing for providing the inkjet droplets. The curable ink used for providing the curable ink layer may be curable by UV radiation, or may be curable by heating or any other way.

The curable ink layer provided on the surface of the transparent sheet may comprise a fully closed ink layer, may comprise a plurality of ink layer portions next to each other having open space in between the plurality of ink layers portions on the surface of the transparent sheet and may comprise a curable ink layer or a plurality of ink layer portions having open space inside the area of the curable ink layer (e.g. an open square or an open circle).

The curable ink layer may be provided by depositing single ink drops per position on the surface of the transparent sheet and may also be provided by image-wise depositing several ink drops on top of each other in the same position of the surface of the transparent sheet, provided that the total thickness does not exceed 35 micron.

The thickness of the graphical layer according to the invention is at most 35 micron. It has been found that the thickness of the graphical layer is essential for achieving a good durability of the membrane for switching. The thickness of the graphical layer can be controlled very accurately using inkjet printing (e.g. by suitably selecting a droplet size, droplet spreading, droplet positioning, number of ink layers), while a high quality (e.g. high-resolution) image may be obtained.

The maximum thickness of the graphical layer, required for durability of the switching membrane, may be affected by the flexibility of the cured ink layers. The maximum thickness of the graphical layer may be increased by using a curable ink composition or by applying a different curing technique, which provides more flexibility to the cured ink layer.

In an embodiment of the method, the thickness of the graphical layer is at most 24 microns. It has been found that at this thickness the mechanical durability of the membrane is further improved for operating the (manual) switch for at least 5.000.000 times, whereby the membrane is not visibly degraded.

Commonly in inkjet printing for providing a full color image a combination is used of a cyan ink, a magenta ink, a yellow ink and a black ink. A layer thickness of a single UV inkjet layer may be controlled in the range of about 10 to about 15 micron, by carefully selecting inkjet printing parameters, such as droplet size, droplet size modulation, print resolution, color density of the ink, ink droplet spreading on the surface of the transparent sheet, ink curing settings, etc. The single inkjet layer may be formed by depositing a single ink droplet per position of the image on the surface of the transparent sheet. For providing full color printing two layers of ink may be used; commonly the colors red, green and blue are provided by depositing two ink droplets, being selected from the cyan, magenta and yellow ink, on top of each other. However any other color inks may also image-wise be provided according to the invention using inkjet printing, such as light magenta ink, light cyan ink, grey ink, white ink, orange ink, red ink, green ink, blue ink, etc in order to obtain a high quality image. The graphical layer according to the invention is cured in step c). The level of curing during curing of the curable ink layer may be controlled accurately using curing techniques. The curing may be carried out by providing UV radiation to the graphical layer or may be provided by providing heat to the graphical layer. The (level of) curing may be adapted in order to obtain a better adhesion of the graphical layer to either the transparent sheet and/or the backing layer. The level of curing may also be adapted in order to obtain a better flexibility of the cured graphical layer. As a result the level of curing may be adapted in order to improve the durability of the resulting switching membrane.

The flexible layer is formed in step d) by providing an ink layer using a printing other than inkjet printing over the graphical layer. The flexible layer may be relatively thin (e.g. 10 microns) while obtaining an opaque backing color, such as white. The inks, which can be used in a printing technique such as screen printing may contain color pigments, which may be larger than the pigment sizes suitable for inkjet printing. A relatively thin layer of screen printed ink may already provides an sufficient opacity, while an inkjet printed ink layer would be typically 60 micron in order to provide a similar opacity.

The flexible layer may have one (monochrome) background color and may have a limited number of background colors (e.g. two or three basic colors such as white, black and a spot color). In an alternative embodiment the flexible layer may comprise two printed layers. For example the flexible layer may comprise a first white opaque layer deposited over the graphical layer and a second grey layer deposited over the first layer of the flexible layer. The flexible layer may also be (locally) translucent to a predetermined extent to allow backlighting of the switching membrane.

The flexible layer may be formed at relatively low cost of production by using screen printing, since the ink layer thickness having a suitable opacity is thinner than for inkjet printing and a single screen for providing a background color is not image dependent and therefore such screen may be used for varying images or several batches of switching membranes.

The ink layer is provided over the graphical layer. Since the graphical layer may comprise open spaces in between ink layer portions, the ink layer of the flexible layer may in some regions be deposited on the ink layer portions of the graphical layer, while in other regions may be deposited directly on the surface of the transparent sheet.

In an embodiment of the method, the graphical layer comprises at least two layers of curable ink. The advantage of the use of the at least two layers of curable ink is that a high-quality full color image may easily be provided by the mixing of the color of at least two ink droplets, which are deposited on top of each other, provided that the total thickness does not exceed 35 micron, more preferably does not exceed 24 micron. Also the color image may have a high resolution, corresponding to the size of the ink droplets.

In an embodiment of the method, the curable ink layer comprises curable ink, which is curable by UV radiation and step c) comprises providing UV radiation to the graphical layer. Inks which are curable by UV radiation are commonly available. UV curing techniques for curable inks is commonly known and devices for providing UV radiation for UV curing of inkjet images are widely available. An UV inkjet printing device, such as an Oce® Arizona 550, may be employed in order to carry out both step b) and c) of the method according to the invention for making a switching membrane.

An advantage of UV radiation curing of the graphical layer is that the curing step may be fast and the degree of curing of the graphical layer may be controlled accurately.

In an embodiment of the method, the curable ink layer comprises curable ink, which is curable by heating and step c) comprises providing heat to the graphical layer. Inks which are curable by heating are commonly available and heating techniques for ink layers on substrates are commonly known and devices for providing heat to inkjet images are widely available. An advantage of curing by heat is that devices for providing heat to inkjet images are available at low cost.

In an embodiment of the method, the formed flexible layer provides an opaque white background. The advantage of the opaque white background is, that the reflection of the color of the graphical layer is optimized, while any parts of the switching elements behind the switching membrane (such as conductive tracks of the switching elements) will not be visible.

In an embodiment of the method, step d) comprises: d1) forming an adhesion layer over the graphical layer, and d2) forming the flexible layer over the adhesion layer.

The adhesion layer may be provided over the graphical layer in order to obtain a better adhesion of the flexible layer. As the graphical layer may comprise open spaces in between ink layer portions, the adhesion layer may in some regions be deposited on the ink layer portions of the graphical layer, while in other regions may be deposited directly on the surface of the transparent sheet.

The flexible layer is formed over the adhesion layer. The adhesion layer may comprise a pattern. The flexible layer may be deposited on the adhesion layer and may be deposited on the graphical layer, depending on the pattern of the adhesion layer.

The pattern of the adhesion layer may be optimized for obtaining a large contact area with the flexible layer. The pattern of the adhesion layer may also be optimized for obtaining reduced mechanical stress in the layers of the membrane after or during deformation of the membrane. For example a part of the membrane may be permanently deformed using a vacuum deforming technique for obtaining an embossed area. Such an embossed area of the membrane may be used as a switching button.

In a further embodiment of the method, the adhesion layer has the same color as the flexible layer. The advantage is that the adhesion layer will not be visible and as such will not affect the color image of the graphical layer. Moreover any pattern may be selected for the adhesion layer while not disturbing the color image of the graphical layer or the color of the flexible layer.

In a further embodiment of the method, the adhesion layer comprises a printed pattern and wherein step d1) comprises providing the adhesion layer using inkjet printing.

A pattern of the adhesion layer may be obtained by printing a pattern using an inkjet printing technique. The advantage is that the pattern of the adhesion layer may be provided very accurately by using inkjet printing. For example the position, resolution and thickness of the pattern may be controlled accurately (e.g. by suitably selecting a droplet size, droplet spreading, droplet positioning, number of ink layers).

In an even further embodiment of the method, the adhesion layer is provided by a hot melt ink. Hot melt inks may suitably be selected for providing adhesive properties at regular operating temperatures of the switching membrane (commonly around room temperature), while the hot melt inks may be jettable by inkjet print heads at elevated temperatures of the print heads.

In an even further embodiment of the method, the adhesion layer is provided by a curable ink and wherein the method further comprises step e) curing the adhesion layer. Curable inks may suitably be selected for providing adhesive properties of the adhesion layer. Furthermore the curing step of the curable inks may be optimized for obtaining proper adhesion towards the flexible layer. The curing step e) may be carried out at any time after forming of the adhesion layer. For example the curing step of the adhesion layer may be fully or partly carried out before, during or after forming of the flexible layer.

In an even further embodiment step c) curing of the graphical layer may also be carried out together with (or at the same instance as) step e) curing of the adhesion layer. An advantage is that the time and energy consumption for curing both layers, graphical layer and adhesion layer may be minimized. This embodiment may be favorable, for example in case the pattern of the adhesion layer and the image of the graphical layer will not disturb each other while the curable ink is not cured yet.

In a further embodiment of the method, the printed pattern comprises circular patterns. The circular patterns may be selected for obtaining reduced mechanical stress in the membrane after or during deformation of the membrane. For example a part of the membrane may be permanently deformed using a vacuum deforming technique for obtaining an embossed area. Such an embossed area may be used as a switching button.

In a different aspect of the invention a switching device for switching operation is provided, the switching device comprising a membrane for indicating a switch button, the membrane comprising: a transparent sheet, a graphical layer, the graphical layer being arranged on a surface of the transparent sheet and being formed by providing a curable ink layer on the surface of the transparent sheet using inkjet printing and curing the graphical layer, wherein the graphical layer has a thickness of at most 35 micron, and a flexible layer, the flexible layer being arranged over the graphical layer and being formed by providing an ink layer using a printing technique other than inkjet printing.

The membrane for indicating a switch button for switching operation may be obtained by performing the method according to the invention.

### BRIEF DESCRIPTION OF THE DRAWINGS

Hereinafter, the present invention is further elucidated with reference to the appended drawings showing non-limited embodiments and wherein

FIG. 1A shows a front view of a switching membrane

FIG. 1B shows an enlarged side view along the line II-II in FIG. 1A of the switching membrane

FIG. 2A shows a perspective view of a flatbed inkjet printing device

FIG. 2B schematically illustrates a flatbed inkjet printer provided with radiation sources

FIG. 3A-3D show a front view to illustrate the steps of a first embodiment of the method in accordance with the present invention;

FIG. 3E-3H show a side view to illustrate the steps of a first embodiment of the method in accordance with the present invention;

FIG. 4A-4D show a side view along the line II-II in FIG. 3D of the first embodiment of a method according to the present invention;

FIG. 5A-5E show a front view to illustrate the steps of a second embodiment of the invention comprising an adhesion layer

FIG. 5F-5J show a side view to illustrate the steps of a second embodiment of the invention comprising an adhesion layer

FIG. 6A-6D show a front view to illustrate the steps of a third embodiment of the invention comprising an adhesion layer

FIG. 6E-6H show a side view to illustrate the steps of a third embodiment of the invention comprising an adhesion layer

### DETAILED DESCRIPTION

In the drawings, same reference numbers refer to same elements.

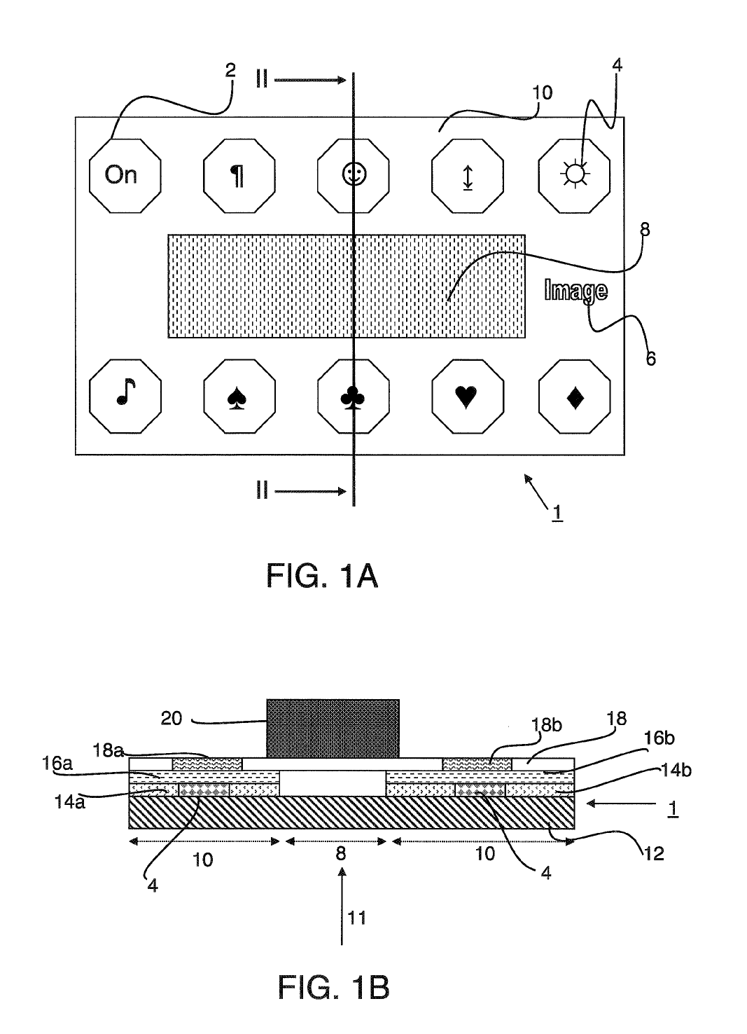

In FIGS. 1A and 1B a prior art switching membrane 1 is illustrated. In FIG. 1A a front view of the switching membrane is shown. The switching membrane 1 comprises a graphical area 10 for indicating a switch button, a number of switch areas 2, each of the switch areas comprising a switch indicator 4 for indicating the function of the switch button, a graphical element 6 for providing additional information and a display area 8. The graphical area 10 of the switching membrane has a background color, for example white. The display area 8 of the switching membrane is transparent in order that an electronic display device 20 may be visible, which is positioned behind the display area 8.

In FIG. 1B schematically shows an enlarged side view of the switching membrane 1 along the line II-II in FIG. 1A. In FIG. 1B the viewing direction of the switching membrane is indicated by arrow 11. When viewing the switching membrane 1 in the direction of arrow 11a user will see a display area 8 and a graphical area 10.

The switching membrane comprises a transparent sheet 12, a graphical layer (14a and 14b), which comprises image elements for providing switch indicators 4 and graphical elements 6 and a flexible layer (16a and 16b), for providing a background color. The switching membrane 1 may further comprise a switch layer 18, comprising electromechanical switch elements 18a and 18b. Behind the switching membrane a display device 20 is provided. The switch elements 18a and 18b are both positioned behind a switch indicator 4a and 4b in the graphical layer 14. The display device 20 is positioned behind display area 8.

In FIG. 1B the layers are shown schematically. The transparent sheet may have a thickness in the order of 200-400 microns. The graphical layer and flexible layer may have a varying thickness in the order of 10-100 microns. The thickness of the graphical layer may vary depending on the image elements provided in the graphical layer. Commonly both the graphical layer and the flexible layer are provided by screen printing technique. The switch layer 18 may have a thickness in the order of 100 microns-several centimeters, depending on the type of switch elements chosen.

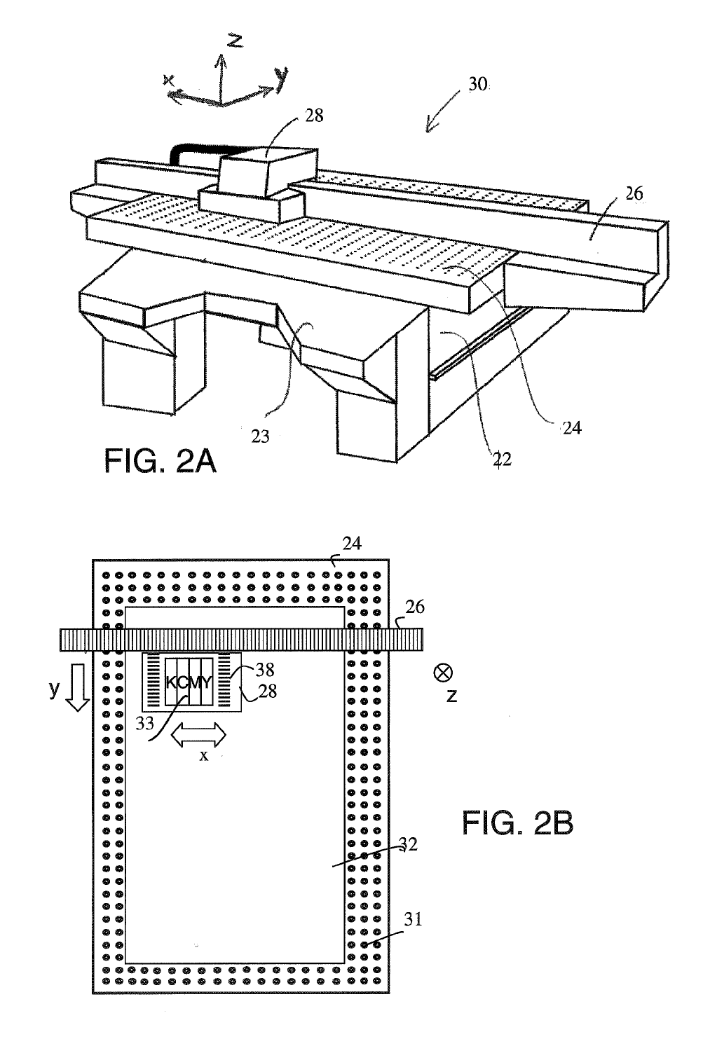

FIG. 2A shows a flatbed UV inkjet printing device 30 for printing an image or text on a relatively large object, in particular on a relatively large and flat object. Such a printing device 30 is well known in the art, such as an Oce® Arizona 550. The printing device 30 comprises a support assembly 22 on which a printing surface 24 is arranged. As illustrated, the printing surface 24 may be provided with suction holes for pulling the object onto the printing surface 24 and thereby holding the object flat on the printing surface 24. A guiding assembly 26 is provided for supporting and guiding a carriage 28. The carriage 28 is movably supported by the guiding assembly 26 such that the carriage 28 may be moved over the printing surface 24. For example, the guiding assembly 26 may be movably supported on the support assembly 22 such that the guiding assembly may be moved in a y-direction (as indicated in FIG. 2A) and the carriage 28 may be moveably supported by the guiding assembly 26 such that the carriage may be moved in a x-direction guided by the guiding assembly 26. The carriage 28 is provided with a printing element such as an inkjet print head for printing the image or the text on the object arranged on the printing surface 24 by ejecting ink drops at predetermined positions. It is noted that the guiding assembly 26 and/or the carriage 28 may be supported such that they may be moved in a z-direction, thereby enabling to print on different media (i.e. objects) having a different dimension in the z-direction (when positioned on the printing surface 24).

The printing device 30 further comprises an interface assembly 23. The interface assembly 23 is configured for connecting a roll-to-roll web processing device to the printing device 30 such that the printing device 30 is enabled to print on a media that is supplied from a roll instead of a medium that is positioned on the printing surface 24.

FIG. 2B schematically shows the flatbed UV inkjet printing device 30 when viewing the device 30 in FIG. 2A in z-direction from above. In FIG. 2B the printing surface 24 comprises suction holes 31. The printing surface 24 supports and fixes an image receiving member 32. In the method according to the invention the image receiving member 32 may be a transparent sheet 12, and the flatbed UV inkjet printing device 30 may be used to form a graphical layer 14 on top of the transparent sheet 12.

Several print heads, may be mounted on the carriage (28) which can be moved in reciprocation along the guiding assembly 26 extending across the image-receiving member, i.e. the main scanning direction.

The print heads 33 of a particular color, e.g. black (K), cyan (C), magenta (M), yellow (Y), are arranged in the main scanning direction. Each print head comprises a number of discharging elements which are typically arranged in a single array or in multiple arrays in the sub scanning direction. Each discharging element is connected via an ink duct to an ink reservoir of the corresponding colour. Each ink duct is provided with means for activating the ink duct and an associated electrical drive circuit. For instance the ink duct may be activated thermally, and/or piezo electrically, or acoustic, or electro statically. When the ink duct is activated an ink drop is discharged from the discharge element in the direction of the printing surface 24 and forms a dot of ink on the image-receiving member. The carriage further supports two radiation sources 38 for irradiating the ink dots deposited on the image-receiving member. This guiding assembly 26 can be moved back and forth along the image-receiving member, i.e. in the sub scanning direction. The image receiving membrane 32 is kept stationary on the printing surface 24.

The radiation sources 38 irradiate at least the ink dots deposited during the print swath. The radiation sources, in casu L-shaped xenon flash lamps, are mounted to both sides of the carriage in such a way that all the ink jetted onto the image-receiving member is exposed to the radiation. The print heads are shielded to prohibit undesired exposure to UV irradiation. At the end of each print swath, the lamp positioned upstream with respect to the print heads is instantly switched off when crossing the edge of the image-receiving member or the printing surface 24 to avoid reflections from and/or heating up of the printing surface 24. Subsequently in the reciprocating movement the same lamp is instantly switched on and when reaching the opposite edge of the image-receiving member the other lamp is switched off. By doing so print quality degradation due to undesired UV back reflections or warming up of the image-receiving member is avoided or at least severely limited.

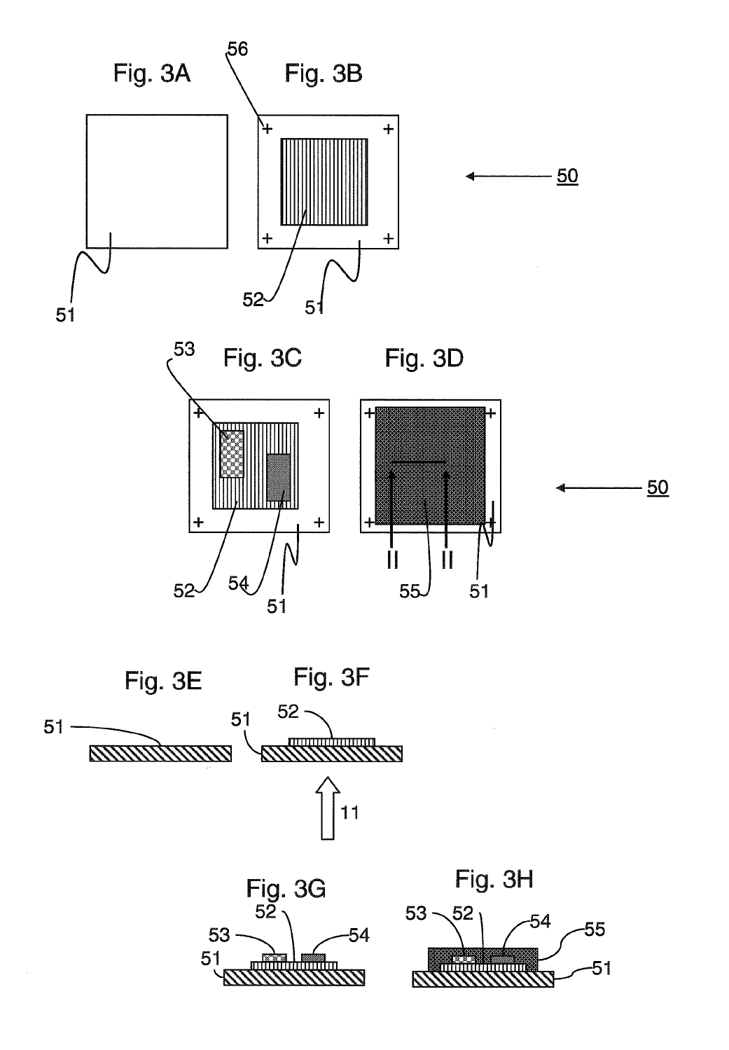

FIG. 3A-3D show a front view to illustrate the steps of a first embodiment of the method in accordance with the present invention. FIG. 3E-3H show a side view to illustrate the steps of a first embodiment of the method in accordance with the present invention. In FIG. 3E-3H the viewing direction of the switching membrane is indicated by arrow 11. The first embodiment comprises forming a graphical layer which comprises two layers of curable ink. The two layers of the graphical layer are formed by providing a UV curable ink using inkjet printing. The particular set of color inks used in the first embodiment is cyan ink, magenta ink, yellow ink and black ink. Color mixing of the color inks may be provided by depositing two inkjet drops on top of each other, thereby forming the two layers of curable ink. The first layer and second layer of the graphical layer are formed by using an UV inkjet printing device, for example by using an Oce® Arizona 550 printer. The thickness of the first layer and the second layer of the graphical layer is controlled in order that the thickness of the graphical layer is at most 35 micron, more preferably at most 24 micron.

FIGS. 3A and 3E show a first step of a first embodiment, wherein a transparent sheet 51 is provided. FIGS. 3B and 3F schematically show a second step of the first embodiment, wherein a first curable ink layer 52 of the graphical layer is formed on top of the surface of the transparent sheet 51. The first curable ink layer is cured by providing UV irradiation to the graphical layer by the radiation sources 38 of the inkjet printing device. The first curable ink layer may be fully or partially cured before forming the second curable ink layer.

FIGS. 3C and 3G schematically show a third step of the first embodiment, wherein the second curable ink layer of the graphical layer is formed 53, 54 over the first curable ink layer 52 of the graphical layer. The second curable ink layer is cured by providing UV irradiation to the graphical layer by the radiation sources 38 of the inkjet printing device.

The first and second curable layer may be formed by providing ink dots on the transparent sheet adjacent to each other in a plurality of passes of the print head carriage 28 (e.g. 4 passes or 8 passes) in the scanning direction over the transparent sheet 51 for each part of curable ink layer. The deposited curable ink dots may be cured after each pass of the print head carriage 28 or the curable ink layer may be cured after all ink dots forming the curable ink layer have been deposited in the plurality of passes of the print head carriage 28.

Additionally markers 56 may be formed on the transparent sheet 51 outside of the graphical layer during the second or third step by using the inkjet printing device. The markers 56 may be used in order to align the position of the flexible layer with the graphical layer during the fourth step.

FIGS. 3D and 3H schematically show a fourth step of the first embodiment, wherein a flexible layer is formed over the graphical layer. The flexible layer in the fourth step is formed by using a printing technique other than inkjet printing. In particular the flexible layer may be formed by using screen printing. In FIG. 3H is schematically shown that the area of the flexible layer is wider than the area of the graphical layer, and that the flexible layer in some parts of that area is directly deposited on the transparent sheet 51.

In an alternative embodiment of the method the graphical layer may comprise one layer of curable ink. The one layer of curable ink is image-wise provided by depositing inkjet droplets adjacent to each other. In an embodiment the particular set of inks used may, besides cyan ink, magenta ink, yellow ink and black ink, additionally include red ink, green ink and blue ink in order to obtain a full color image. An advantage is that these colors don't have to be provided by depositing ink droplets of cyan ink, magenta ink and yellow ink on top of each other and that one layer of ink is enough to provide a full color image.

In an alternative embodiment the particular set of inks used may also include light magenta, light cyan and/or white ink. An advantage of an extended set of color inks is that the maximum thickness of the graphical layer may easily be reduced to a thickness of 35 micron, preferably to a thickness of at most 24 micron, while obtaining a full color image. In particular a white ink may be used in the graphical layer by using inkjet printing in order to improve a white backing color provided by a flexible layer.

Several switching membranes were made, wherein the graphical layer was formed using an Oce® Arizona 550 GT UV inkjet device. The color inks used was cyan ink, magenta ink, yellow ink and black ink. The thickness of the graphical layer was accurately controlled by selecting inkjet printing parameter settings of the Oce® Arizona 550 printer device, such that one printed curable ink layer had a thickness of 12 micron. The flexible layer was formed by using screen printing. The mechanical durability of the resulting switching membranes was tested (Table 1). The standard for achieving suitable durability of a switching membrane is 1 million switching times or more before visible cracks occur.

TABLE 1
mechanical durability of switching membrane

| Number of ink | Total thickness of | Number of switching times |
|---|---|---|
| layers printed | graphical layer | before visible cracks |
| 4 layers | 48 micron | <100.000 |
| 3 layers | 36 micron | <1.000.000 |
| 2 layers | 24 micron | >5.000.000 |
| 1 layer | 12 micron | >>5.0000.000 |

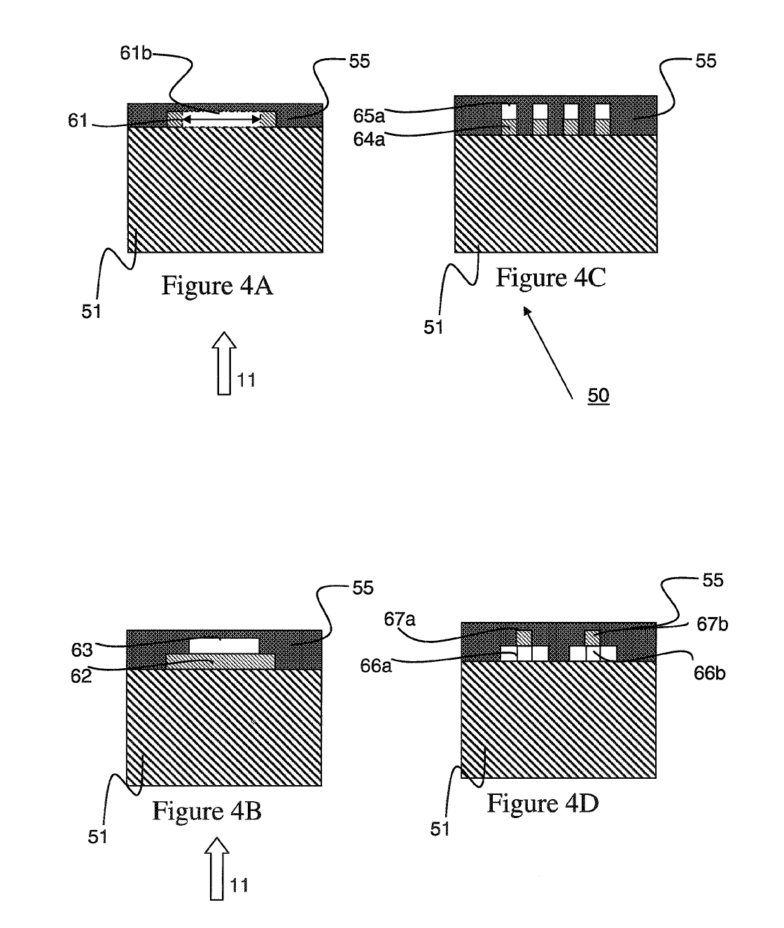

FIG. 4A-4D schematically show a side view along the line II-II in FIG. 3D of the first embodiment of a method according to the present invention.

In FIG. 4A schematically a curable ink layer 61 is shown, which has an open space 61b inside the area of the curable ink layer 61. The curable ink layer 61 may for example have the form of an open square or an open circle in the direction of the surface of the transparent sheet 51. A flexible layer 55 is shown, which also fills the area of the open space 61b of the curable ink layer 61. In this area the flexible layer 55 is in direct contact with the transparent sheet 51.

In FIG. 4B schematically a first curable ink layer 62 and a second curable layer 63 are shown. Both curable layers 62 and 63 are a fully closed layer. The flexible layer 55 is deposited over the curable layers 62, 63 and directly contacts the transparent sheet 51 outside of the area of curable layer 62.

FIG. 4C schematically shows a first curable ink layer 64a, comprising a plurality of ink dots each having an open space between each other, and a second curable ink layer 65a, also comprising a plurality of ink dots each having an open space between each other and being deposited directly on top of the ink dots of the first curable ink layer 64a. The size (width and height) of the ink dots in FIG. 4C are in the order of 10 to 15 micron. When viewing the switching membrane in the direction of arrow 11, a user will see a color, which is the result of a mix of the colors of the ink dots of the first and second ink layer and the background color, provided by the flexible layer 55. In case the background color is white, a user will see a lighter gradation of a full color.

In FIG. 4D schematically a first curable ink layer 66a, 66b and a second curable layer 67a, 67b are shown. The first curable ink layer comprises two ink layer portions 66a and 66b, each comprising a plurality of ink dots being deposited adjacent to each other. The second curable ink layer comprises a plurality of ink dots 67a, 67b each being deposited on one of the two ink layer portions of the first ink layer 66a, 66b.

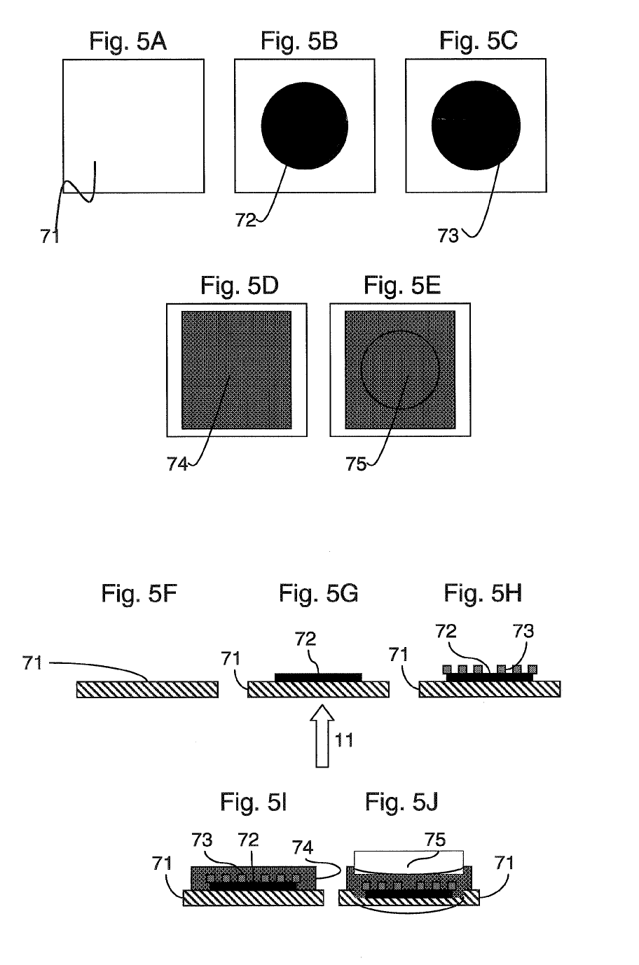

FIG. 5A-5E show a front view to illustrate the steps of a second embodiment of the invention comprising an adhesion layer. FIG. 5F-5J show a side view to illustrate the steps of a second embodiment of the invention comprising an adhesion layer. In FIG. 5F-5J the viewing direction of the switching membrane is indicated by arrow 11.

In the second embodiment an additional adhesion layer is formed over the graphical layer. The adhesion layer comprises a pattern. The pattern is selected in order to reduce mechanical stress within the switching membrane after or during deformation of the membrane. The adhesion pattern may be used in an embossed area of the switching membrane.

FIGS. 5A and 5F show a first step of the second embodiment, wherein a transparent sheet 71 is provided. FIGS. 5B and 5G schematically show a second step of the second embodiment, wherein a graphical layer 72 is formed on top of the surface of the transparent sheet 71. The graphical layer shown in FIG. 5B is a switch indicator. The graphical layer 72 may comprise one, two or more curable ink layers. The graphical layer is formed by using inkjet printing, e.g. by using the UV flatbed inkjet printing device 30. The thickness of the graphical layer is at most 35 micron, more preferably at most 24 micron. The graphical layer is cured by providing UV irradiation to the graphical layer by the radiation sources 38 of the inkjet printing device.

FIGS. 5C and 5H schematically show a third step of the second embodiment, wherein the adhesion layer 73 is formed over the graphical layer 72. The adhesion layer 73 comprises a circular pattern being composed of three circles. The circular pattern of the adhesion layer is centrally aligned with the circular graphical layer 72. The adhesion layer 73 is formed by using inkjet printing of a UV curable ink. The UV curable ink may have the same color as the color provided by the flexible layer (e.g. white). Alternatively the UV curable ink is a transparent ink. The adhesion layer is cured by providing UV irradiation to the graphical layer by the radiation sources 38 of the inkjet printing device. After curing, the adhesion layer provides adhesion to the flexible layer. In an alternative embodiment the adhesion layer may be (fully) cured after the step of forming the flexible layer. The adhesive strength of the adhesion layer may be optimized by controlling the curing settings for curing the adhesion layer (e.g. stepwise curing, partially curing, UV radiation intensities, etc.).

In an alternative embodiment the adhesion layer is formed by using inkjet printing of a hot melt ink. Inkjet droplets of hot melt ink may be provided at an elevated temperature of the inkjet print head. The deposited hot melt ink may provide adhesive strength to the flexible layer at room temperature. The hot melt ink may be selected in order to optimize the adhesive strength towards the flexible layer. The hot melt ink may also be selected in order to optimize the reduction of mechanical stress during deformation of the switching membrane.

FIGS. 5D and 5I schematically show a fourth step of the second embodiment, wherein the flexible layer 74 is formed over the adhesion layer 73 by using a printing technique other than inkjet printing. In particular the flexible layer 74 may be formed by using screen printing. The flexible layer in some area's directly contacts the transparent sheet 71, in other areas contacts the graphical layer 72 and in yet other area's contacts the adhesion layer 73.

FIGS. 5E and 5J schematically show a fifth step of the second embodiment, wherein the switching membrane is locally deformed by using a vacuum deforming technique, whereby an embossed area is provided 75. The embossed area 75 is centrally aligned with the graphical layer 72 and the pattern of the adhesion layer 73. The embossed area 75 is used as a switching button. The switching button is also visibly indicated by the information provided by the graphical layer 72.

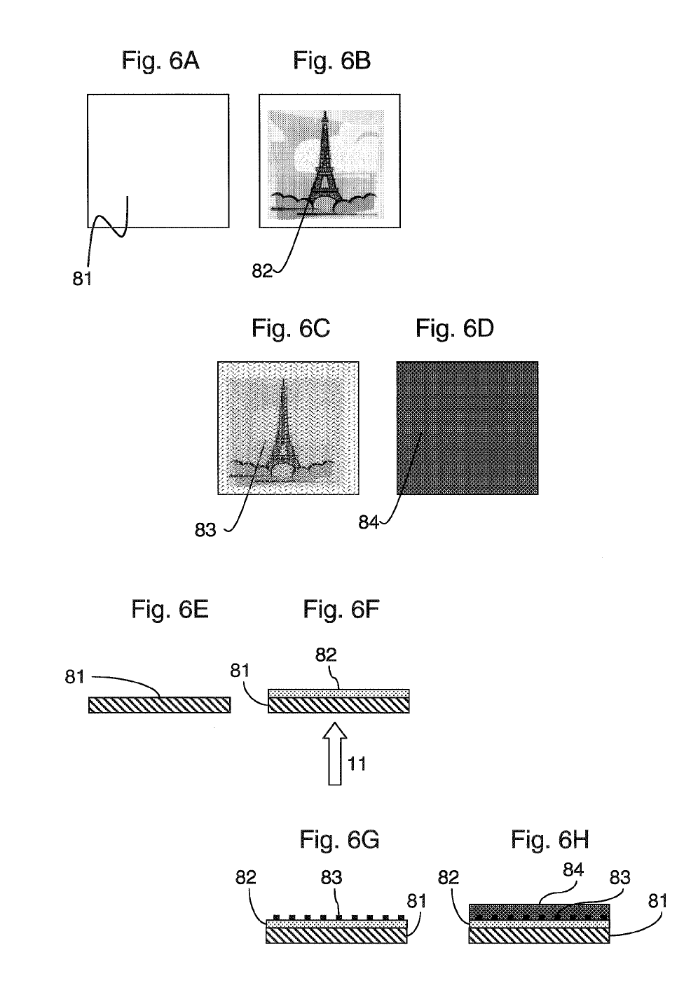

FIG. 6A-6D show a front view to illustrate the steps of a third embodiment of the invention comprising an adhesion layer. FIG. 6E-6H show a side view to illustrate the steps of a third embodiment of the invention comprising an adhesion layer. In FIG. 6E-6H the viewing direction of the switching membrane is indicated by arrow 11.

FIGS. 6A and 6E show a first step of the third embodiment, wherein a transparent sheet 81 is provided. FIGS. 6B and 6F schematically show a second step of the second embodiment, wherein a graphical layer 82 is formed on top of the surface of the transparent sheet 81. The graphical layer shown in FIG. 6B provides an image element, e.g. an image of the Eiffel tower. The graphical layer 82 may comprise one, two or more curable ink layers. The graphical layer is formed by using inkjet printing, e.g. by using the UV flatbed inkjet printing device 30. The thickness of the graphical layer is at most 35 micron, more preferably at most 24 micron. The graphical layer is cured by providing UV irradiation to the graphical layer by the radiation sources 38 of the inkjet printing device.

FIGS. 6C and 6G schematically show a third step of the third embodiment, wherein the adhesion layer 83 is formed over the graphical layer 82. The adhesion layer 83 comprises a regular pattern being deposited over the whole area of the graphical layer 82. The adhesion layer 83 is formed by using inkjet printing, e.g. of a UV curable ink. The pattern of the adhesion layer 83 in FIG. 6G is in some area's deposited on top of the graphical layer 82, while in other area's the pattern of the adhesion layer 83 is in direct contact with the transparent sheet 81.

FIGS. 6D and 6H schematically show a fourth step of the third embodiment, wherein the flexible layer 84 is formed over the adhesion layer 83 by using a printing technique other than inkjet printing. In particular the flexible layer 84 may be formed by using screen printing. The flexible layer in some area's directly contacts the transparent sheet 81, in other area's contacts the graphical layer 82 and in yet other areas contacts the adhesion layer 83.

The pattern of the adhesion layer 83 may be selected in order to optimize the adhesive strength to the flexible layer 84. For example the pattern may be optimized for obtaining a large contact area with the flexible layer 84.

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any combination of such claims are herewith disclosed. Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

1. Method for making a membrane for indicating a switch button for switching operation comprising the steps of:
a) providing a transparent sheet;
b) forming a graphical layer by image-wise providing a curable ink layer using inkjet printing on a surface of the transparent sheet, wherein the graphical layer has a thickness of at most 35 micron;
c) curing the graphical layer; and
d) forming a flexible layer by providing an ink layer using a printing technique other than inkjet printing over the graphical layer.

2. Method according to claim 1, wherein the flexible layer in step d) is formed by using screen printing.

3. Method according to claim 1, wherein the thickness of the graphical layer being at most 24 microns.

4. Method according to claim 1, wherein the graphical layer comprises at least two layers of curable ink.

5. Method according to claim 1, wherein the curable ink layer comprises curable ink, which is curable by UV radiation and wherein step c) comprises providing UV radiation to the graphical layer.

6. Method according to claim 1, wherein the curable ink layer comprises curable ink, which is curable by heating and wherein step c) comprises providing heat to the graphical layer.

7. Method according to claim 1, wherein in step d) the formed flexible layer provides an opaque white background.

8. Method according to claim 1, wherein step d) comprises:
d1) forming an adhesion layer over the graphical layer, and
d2) forming the flexible layer over the adhesion layer.

9. Method according to claim 8, wherein the adhesion layer has the same color as the flexible layer.

10. Method according to claim 8, wherein the adhesion layer comprises a printed pattern and wherein step d1) comprises providing the adhesion layer using inkjet printing.

11. Method according to claim 10, wherein the adhesion layer is provided by a hot melt ink.

12. Method according to claim 10, wherein the adhesion layer is provided by a curable ink and wherein the method further comprises step e) curing the adhesion layer.

13. Method according to claim 10, wherein the printed pattern comprises circular patterns.

14. A switching device for switching operation, the switching device comprising a membrane for indicating a switch button, the membrane comprising:
a transparent sheet;
a graphical layer, the graphical layer being arranged on a surface of the transparent sheet and being formed by providing a curable ink layer on the surface of the transparent sheet using inkjet printing and curing the graphical layer, wherein the graphical layer has a thickness of at most 35 micron; and
a flexible layer, the flexible layer being arranged over the graphical layer and being formed by providing an ink layer using a printing technique other than inkjet printing.

15. The membrane of claim 14, wherein the flexible layer is formed by using screen printing.
